(19) United States
(12) Patent Application Publication
(10) Pub. No.: US 2010/0123307 A1
(43) Pub. Date: May 20, 2010

(54) Extendable Flange Apparatus and Methods

(75) Inventor: Eduardo Coronado, San Pedro Garza Garcia (MX)

Correspondence Address: BAKER & MCKENZIE LLP;PATENT DEPARTMENT, 2001 ROSS AVENUE, SUITE 2300, DALLAS, TX, 75201, US

(73) Assignee: COFLEX S.A. DE C.V., Monterrey (MX)

(21) Appl. No.: 12/576,884

(22) Filed: Oct. 9, 2009

Related U.S. Application Data
(60) Provisional application No. 61/104,221, filed on Oct. 9, 2008.

(51) Int. Cl. E03D 11/00; B23P 11/00

(52) U.S. Cl. 285/56; 29/428

(57) ABSTRACT

The present disclosure generally relates to an extendable flange apparatus having an inner member slidably coupled to an outer member. The outer member includes a first flange portion and an outer tubular body with a central opening defined therethrough. The inner member includes a second flange portion and an inner tubular body operable to be at least partially disposed within the central opening of the outer tubular body of the outer member.

### CROSS-REFERENCE TO RELATED APPLICATION

This application claims priority to U.S. Provisional. App. Ser. No. 61/104,221 filed on Oct. 9, 2008, which is hereby incorporated by reference in its entirety for all purposes.

### TECHNICAL FIELD

The present disclosure generally relates to flanges for use in plumbing applications, and more particularly to flanges having extendable members.

### BACKGROUND

Various flanges have been used to connect the discharge of a plumbing fixture to the waste drain pipe of a plumbing system. In some instances, the connection to the waste drain pipe is often found in the floor of a building, but the height of a finished floor sometimes makes the connection to the waste drain pipe inaccessible. FIG. 1 is an exploded view of the installation of a plumbing fixture 100 with a conventional, non-extendable flange apparatus 102. Due to the height of the finished floor 104, the flange apparatus 102 is seated in a recessed area below the finished floor level. As such, when the plumbing fixture 100 is disposed on top of the finish floor 104, the discrepancy between the seating level of the flange 102 and the finished floor level creates a gap between the discharge 106 of the plumbing fixture 100 and the top opening 108 of the flange 102. To accommodate for the gap, a wax ring 110 of suitable thickness is disposed between the discharge 106 and the top opening 108 of the flange 102. Adding a wax ring 110, however, introduces an additional source of leakage and increases the difficulty of installation.

### BRIEF SUMMARY

The present disclosure generally relates to extendable water closet flanges and methods for installing such water closet flanges. In one embodiment, the extendable flange apparatus includes an outer member comprising an outer tubular body and a first flange portion extending outwardly from an upper end portion of the outer tubular body, the first flange portion defining a first plane. The extendable flange further includes an inner member slidably coupled to the outer member, the inner member comprising an inner tubular body and a second flange portion extending outwardly from an upper end of the inner tubular body, the second flange portion defining a second plane. The outer tubular body has a central opening defined therethrough, and the inner tubular body is at least partially disposed within the central opening of the outer tubular body, the inner tubular body being operable to slide longitudinally, from a leveled position to an extended position. The first and second planes of the first and second flange portions, respectively, are substantially coplanar when the inner tubular body is in the leveled position, and the first plane is in a spaced relation with the second plane when the inner tubular body is in the extended position.

Another embodiment of the extendable flange apparatus of the present disclosure comprises an outer member comprising an outer tubular body and a first flange portion extending outwardly from an upper end portion of the outer tubular body, the first flange portion defining a first plane. The extendable flange also includes an inner member slidably coupled to the outer member, the inner member comprising an inner tubular body, a second flange portion extending outwardly from an upper end of the inner tubular body, the second flange portion defining a second plane, and a sealing member disposed at the upper end of the inner tubular body, the sealing member operable to provide a substantially sealed connection to a discharge of a plumbing fixture. The outer tubular body has a central opening defined therethrough, and the inner tubular body is at least partially disposed within the central opening of the outer tubular body, the inner tubular body being operable to slide longitudinally, from a leveled position to an extended position. The first and second planes of the first and second flange portions, respectively, are substantially coplanar when the inner tubular body is in the leveled position, and the first plane is in a spaced relation with the second plane when the inner tubular body is in the extended position.

Related methods for assembling and installing the disclosed flange apparatus between plumbing fixture discharges and drainage outlets are also described. For example, the ability to extend the inner member of the flange allows for a connection to the plumbing fixture discharge at the finished floor level regardless of whether the flange is seated at the finished floor level or below the floor level. Thus, the flange according to the present disclosure can be used in varying plumbing applications.

### BRIEF DESCRIPTION OF THE DRAWINGS

Reference is now made to the following descriptions taken in conjunction with the accompanying drawings.

FIG. 1 illustrates an exploded view of a plumbing fixture installed with a conventional flange apparatus;

FIG. 2A illustrates a perspective view of an embodiment of an extendable flange apparatus in accordance with the present disclosure;

FIG. 2B illustrates a perspective view of the extendable flange apparatus shown in FIG. 2A in an extended position;

FIG. 3A is a cross-sectional view of the extendable flange apparatus shown in FIG. 2A;

FIG. 3B is a cut-away, perspective view of the extendable flange apparatus shown in FIG. 2A;

FIG. 4A is a perspective view of another embodiment of an extendable flange apparatus installed below a finished floor level;

FIG. 4B is a perspective view of the extendable flange apparatus shown in FIG. 4A in an extended position;

FIG. 5 is a perspective view of the extendable flange apparatus shown in FIGS. 4A and 4B in an extended position connecting a plumbing fixture to a waste drain pipe;

FIG. 6A is a cut-away, perspective view of an exemplary embodiment of an extendable flange apparatus in accordance with the present disclosure;

FIG. 6B is a cut-away, perspective view of the extendable flange apparatus shown in FIG. 6A;

FIG. 7 is a perspective view of an embodiment of an inner member of an extendable flange apparatus according to the present disclosure;

FIG. 8A illustrates a perspective view of another exemplary embodiment of an extendable flange apparatus in accordance with the present disclosure;

FIG. 8B illustrates a perspective view the extendable flange apparatus shown in FIG. 8A after a central detachable portion of a sealing member is removed; and

FIG. 8C illustrates an elevational, cut-away view of an extendable flange apparatus in accordance with the present disclosure.

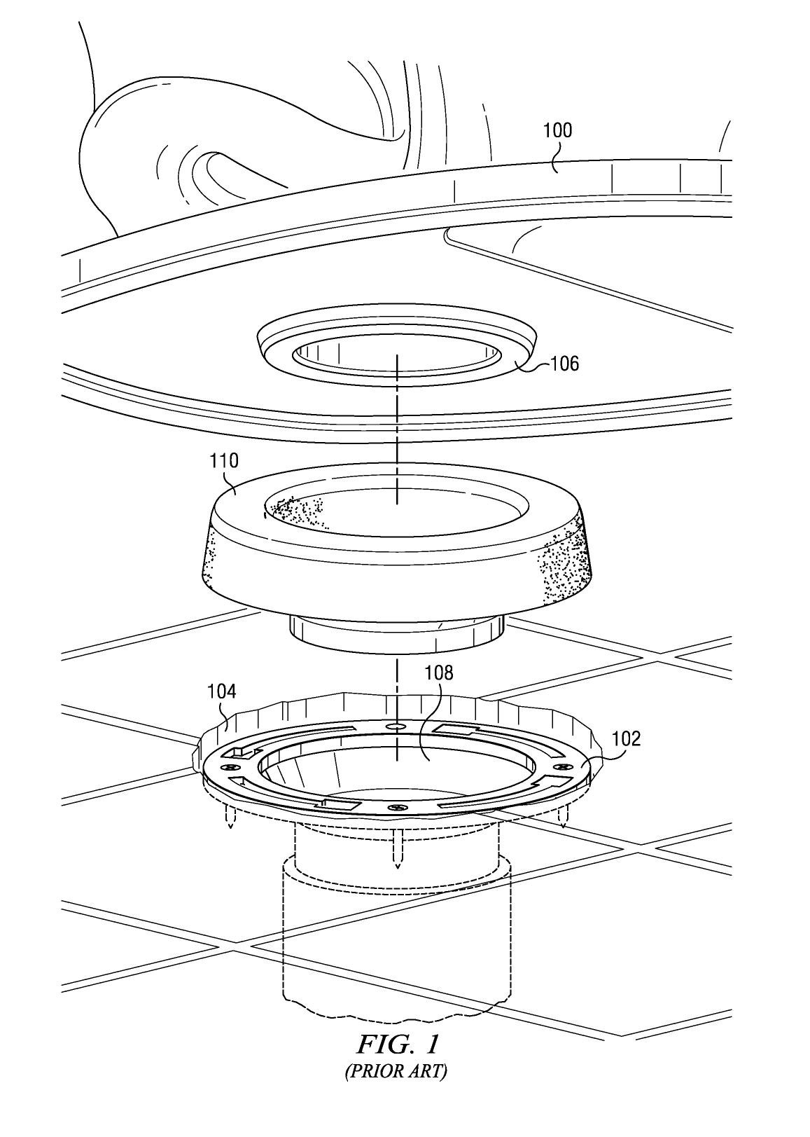

### DETAILED DESCRIPTION

Various aspects of an extendable flange apparatus and related methods for installing the extendable flange between varying plumbing fixture discharges and waste drainpipe outlets according to the present disclosure are described. It is to be understood, however, that the following explanation is merely exemplary in describing the devices and methods of the present disclosure. Accordingly, several modifications, changes and substitutions are contemplated.

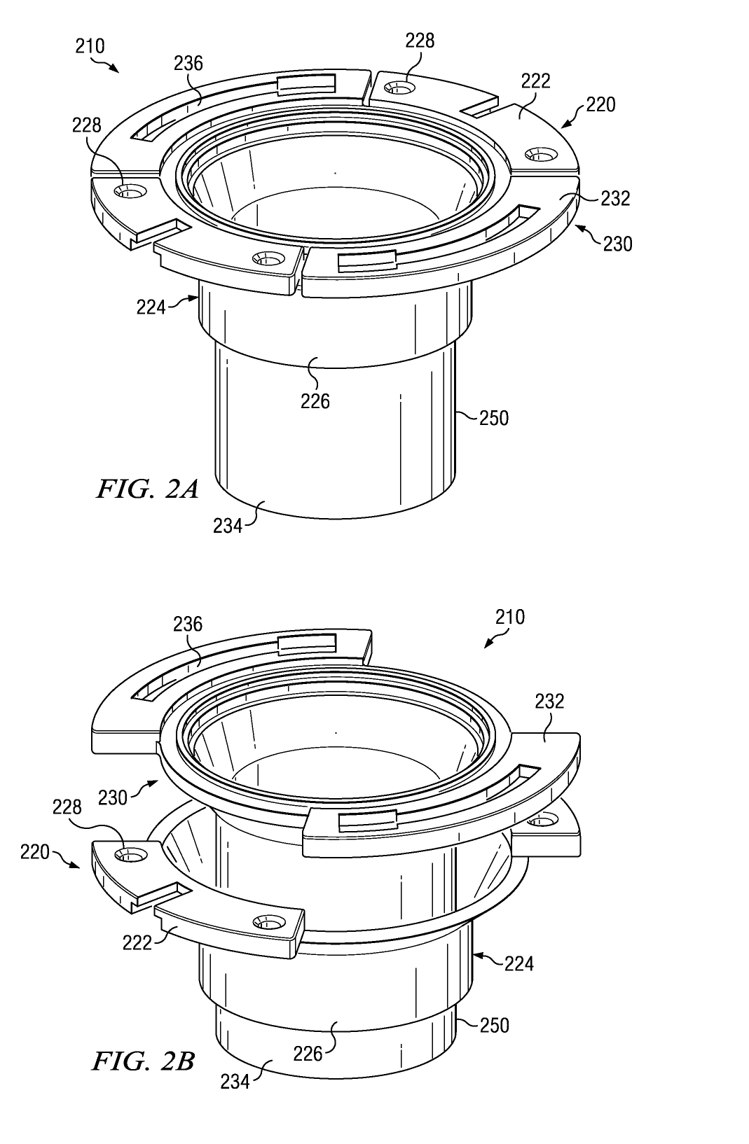

FIG. 2A is a perspective view of an extendable flange apparatus 210 in accordance with the principles of the present disclosure. The extendable flange 210 comprises an outer member 220 and an inner member 230 that are slidably coupled, thereby allowing the inner member 230 to extend upwardly from a level position to an extended position relative to the outer member 220. FIG. 2B is a perspective view of the extendable flange apparatus 210 in an extended position. As such, the extendable flange apparatus 210 is operable to accommodate a potential gap between the seating level of the flange apparatus 210 and the finished floor level without the use of a wax ring or other substitutes for a wax ring.

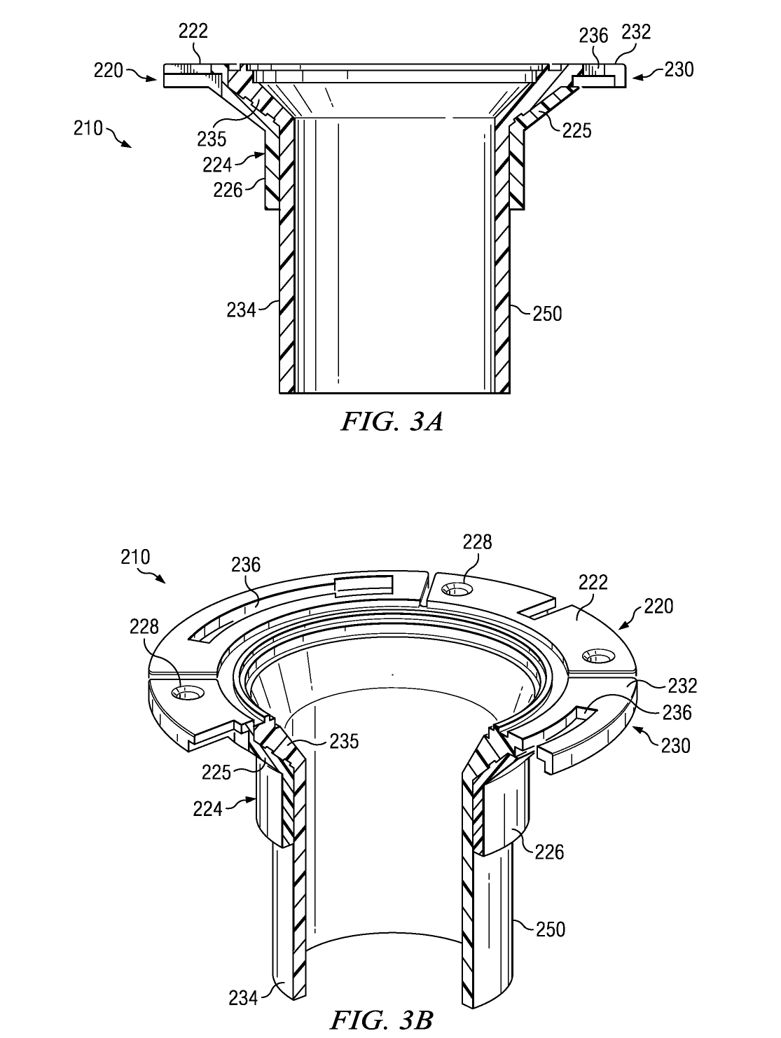

FIGS. 3A and 3B provide a cross-sectional view and a perspective, cut-away view of the extendable flange apparatus 210, respectively. As illustrated, the outer member 220 includes an outer tubular body 224 and a first flange portion 222 extending outwardly from an upper end portion 225 of the outer tubular body 224. The outer tubular body 224 also includes a lower end portion 226. The first flange portion 222 includes bores 228 defined therethrough, and fasteners (not shown), such as threaded screws, can be inserted through the bores 228 to secure the first flange portion 222 against a floor surface. The inner member 230 includes an inner tubular body 234 and a second flange portion 232 extending outwardly from an upper end portion 235 of the inner tubular body 234.

The outer tubular body 224 includes a central opening defined therethrough, and the inner tubular body 234 is at least partially disposed within the central opening of the outer tubular body 224. As illustrated in FIGS. 2A-B and 3A-B, the inner tubular body 234 is operable to slide longitudinally from a leveled position to an extended position. In an embodiment, the first and second flange portions 222 and 232 define first and second planes, respectively, and in the leveled position, the first and second flange portions 222 and 232 are coplanar and level with each other. In the extended position, the first and second planes defined by the first and second flange portions 222 and 232 are in a spaced relation. The second flange portion 232 has openings 236 defined therethrough, and fasteners (not shown) can be inserted through the openings 236 to secure the second flange portion 232 to a plumbing fixture (not shown).

The extendibility of the inner tubular body 234 relative to the outer tubular body 224 permits the use of the extendable flange 210 in varying plumbing applications. The extendable flange 210 is operable to provide a connection to the plumbing fixture discharge at the finished floor level regardless of whether the first flange portion 222 is seated at the finished floor level or below the finished floor level.

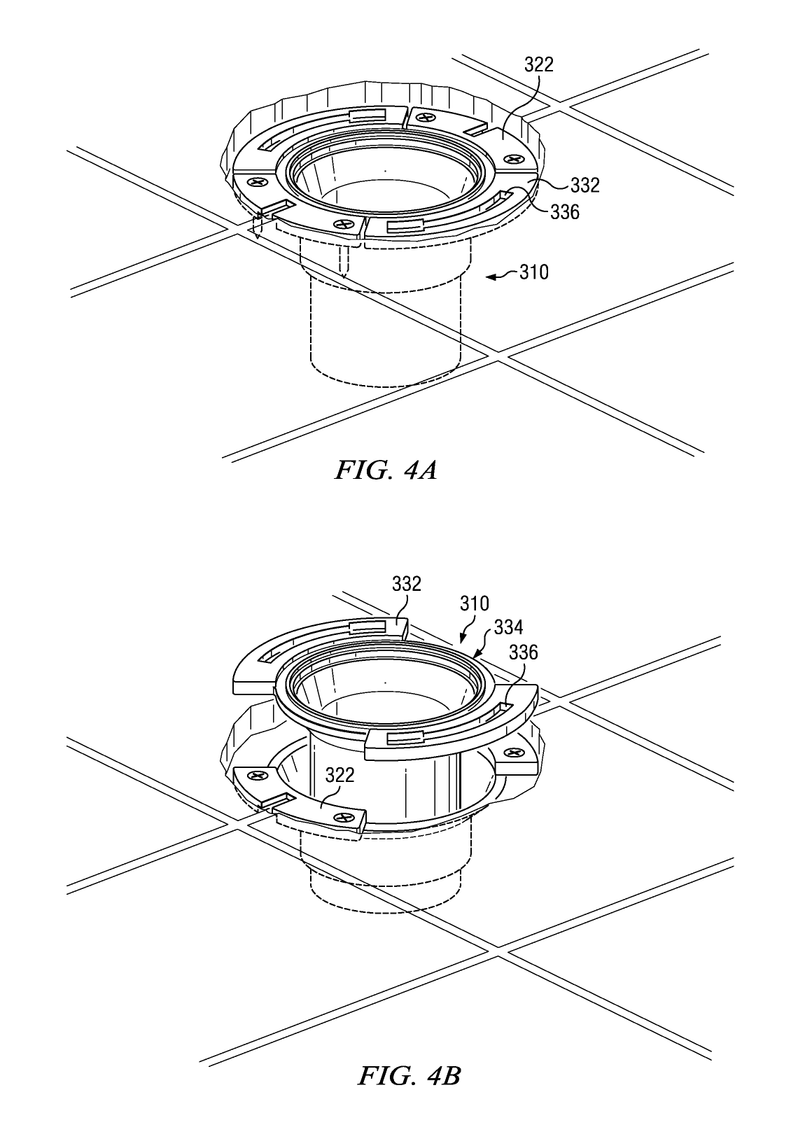

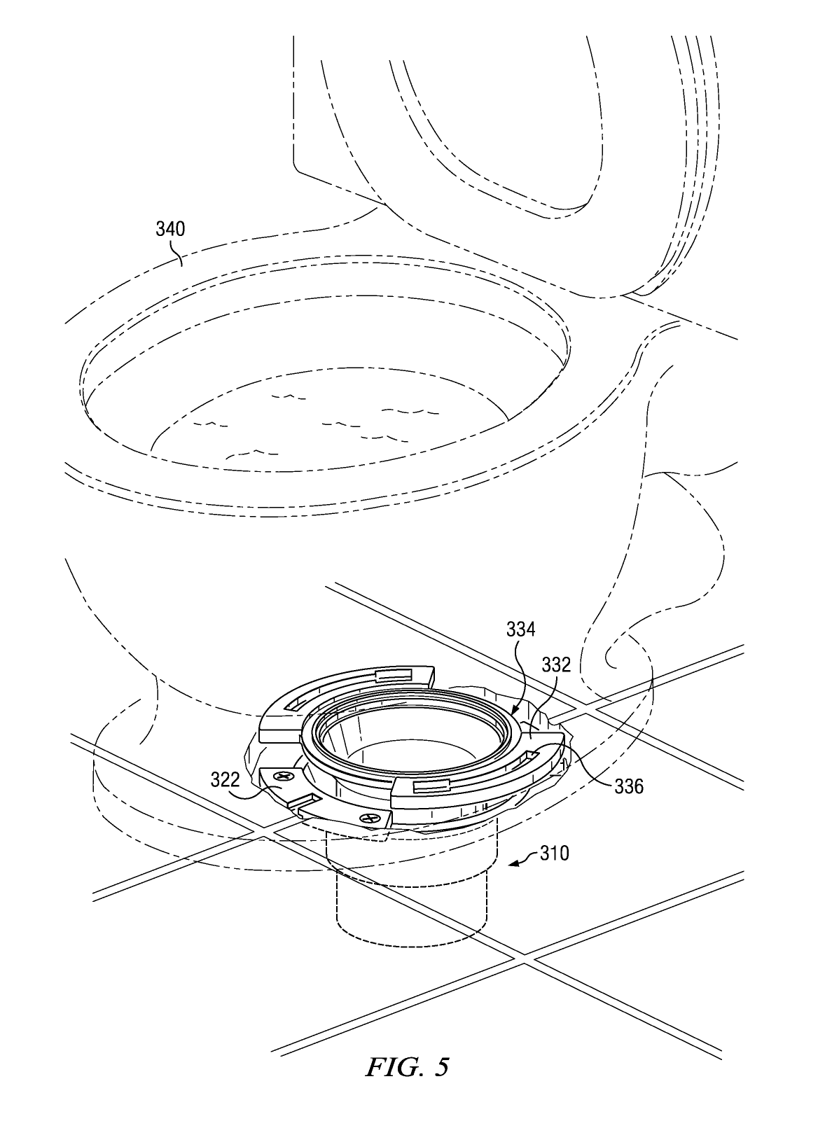

In one embodiment, the first flange portion 322 is seated below the finished floor level to anchor the flange 310, and the second flange portion 332 is initially level with the first flange portion 322 as shown in FIG. 4A. To complete the installation of the flange 310, screws (not shown) are inserted through the openings 336 of the second flange portion 332 and then through openings (not shown) of a plumbing fixture 340 seated at the finished floor level as shown in FIG. 5. Nuts (not shown) are used to engage the screws and secure the second flange portion 332 to the plumbing fixture 340. As the nuts are tightened, the screws pull the second flange portion 332 upwardly to allow the inner tubular body 334 to reach the extended position as illustrated in FIGS. 4B and 5.

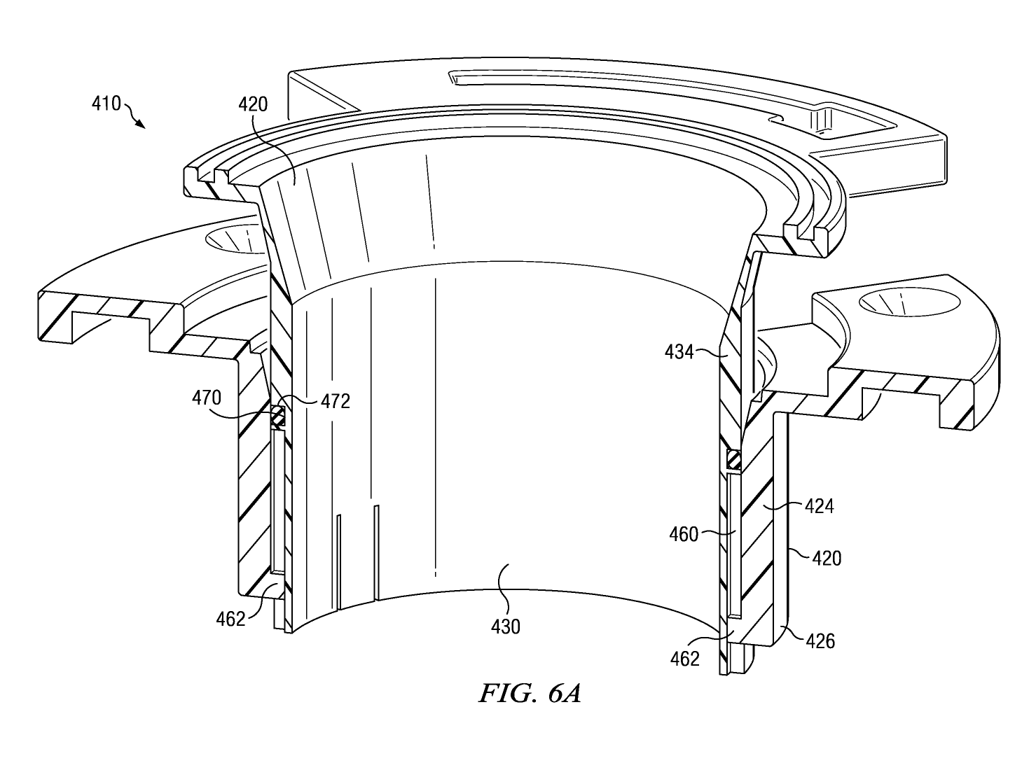

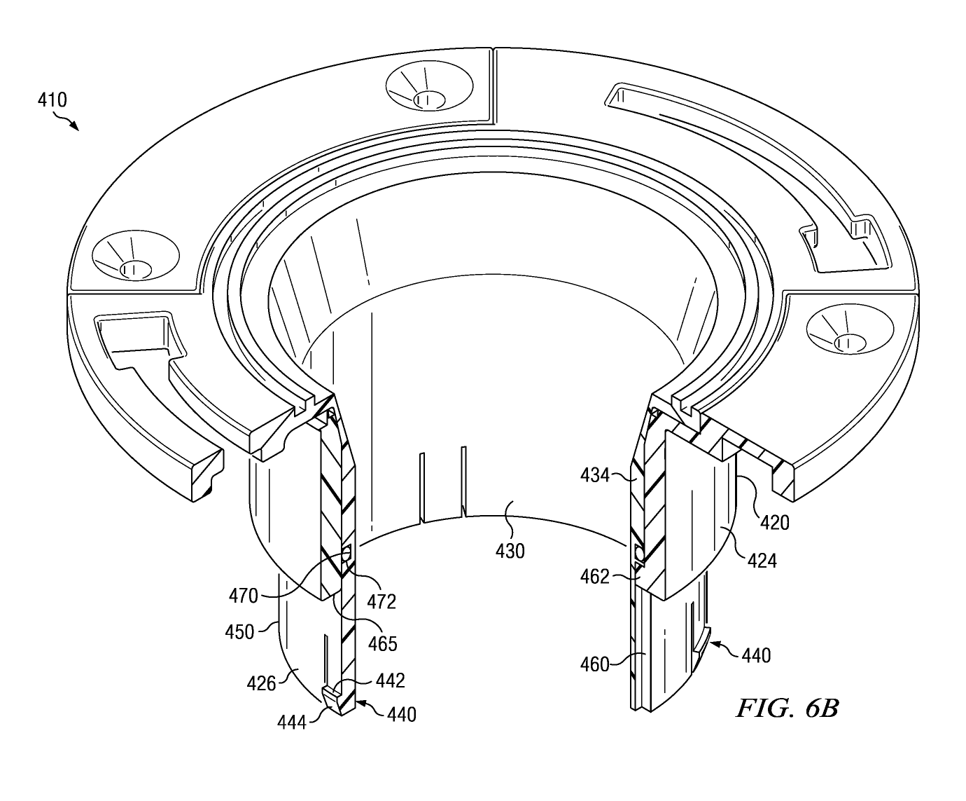

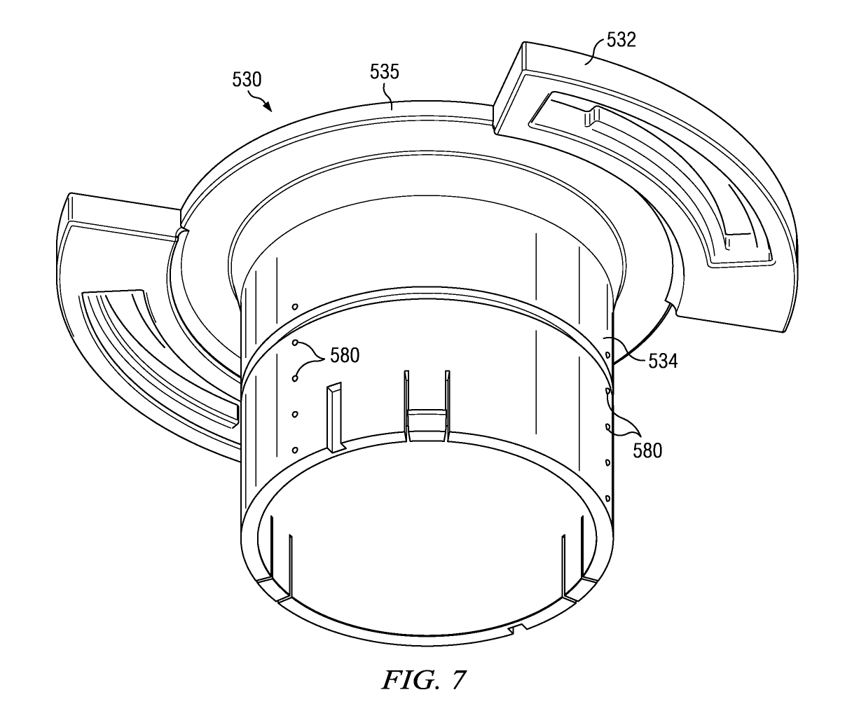

It is to be appreciated that the extendable flange apparatus disclosed herein may be modified to provide a variety of desired functionalities. In some embodiments, the extendable flanges of the present disclosure may include a mechanism for limiting the extension of the flanges and preventing the disassembly of the inner and outer members. FIGS. 6A and 6B are cut-away, perspective views of an exemplary embodiment of an extendable flange 410. The flange 410 may be configured to include at least one latch 440 disposed at a lower end portion 450 of the inner tubular body 434. In the illustrated embodiment, a plurality of latches 440 are provided. The latches 440 are operable to limit the extent which the inner tubular body 434 can be pulled up relative to the outer tubular body 424 by functioning as a mechanical latch against the lower end portion 426 of the outer member 420. As such, the latches 440 are operable to cooperate with the lower end portion 426 of the outer tubular body 424 to prevent the inner and outer members 430 and 420 from being completely disassembled. It is to be appreciated that the latches 440 can be configured to have a variety of shape and profile. In the illustrated embodiment, the latches 440 each comprise a proximal edge portion 442 that is substantially orthogonal to the surface of the inner tubular body and a tapering distal edge portion 444. The tapering distal edge portion 444 allows for easy insertion of the inner member 430 inside the outer member 420, thereby improving the ease of assembly for the flange 410.

In some embodiments, the extendable flanges of the present disclosure may include a mechanism for limiting the rotational movement of the inner and outer members relative to each other. For example, in the embodiment illustrated in FIGS. 6A and 6B, the inner member 430 comprises a longitudinal channel 460 defined in an outer surface of the inner member 430, and the outer member 420 comprises a guide element 462 extending from an inner surface of the outer member 420. The inner and outer members 430 and 420 are aligned such that the guide element 462 extends into the longitudinal channel 460. As such, the guide element 462 and the longitudinal channel 460 are operable to cooperate to substantially limit the rotational movement of inner and outer members 430 and 420 relative to each other. Nonetheless, the guide element 462 is still operable to move along the longitudinal channel 460 to allow for longitudinal movements of the inner and outer members 430 and 420. It is to be appreciated that in some embodiments, depending on the ease of manufacturing, the guide element 462 may be disposed on an outer surface of the inner member 430 instead, and the longitudinal channel 460 may be defined in an inner surface of the outer member 420 instead.

Some embodiments of the extendable flanges of the present disclosure may include a sealing member for providing a seal between the inner and outer members of the flanges. For example, in the embodiment illustrated in FIGS. 6A and 6B, a circumferential groove 470 is defined in an outer surface of the inner member 430, and an o-ring 472 is substantially seated in the groove 472. Disposed in between the inner and outer members 430 and 420, the o-ring 472 is operable to seal any gap that may be present between the inner and outer members 430 and 420. It is to be appreciated that the embodiments provided in FIGS. 6A and 6B are merely exemplary, and other kinds of sealing member may be used in place of the illustrated o-ring 472. It is to be further appreciated that in some embodiments, depending on the ease of manufacturing, the circumferential groove 470 may be defined in an inner surface of the outer member 420 instead.

FIG. 7 is a perspective view of an inner member 530, which may be the inner member of any extendable flange apparatus described in the present disclosure. The inner member 530 includes an inner tubular body 534 and a flange portion 532 extending outwardly from an upper end portion 535 of the inner tubular body 534. The inner member 530 further comprises at least one fitting member 580 disposed on an outer surface of the inner member 530. The inner member 530 is operable to be at least partially disposed within a central opening defined through an outer member (not shown) of an extendable flange such that the inner member 530 and the outer member are slidably coupled. The fitting member 580 is dimensioned to span any gap between the outer surface of the inner member 530 and the inner surface of the outer member, thereby limiting lateral (diametric) movements of the inner member 530 relative to the outer member. For example, wobbling movements would be substantially reduced with the use of the fitting member 580. After a plumbing fixture is installed with an extendable flange comprising the inner member 530, the limitation on the lateral movements of the inner member 530 relative to the outer member is operable to limit external movements of the plumbing fixture due to outside forces exerted on the plumbing fixture, thereby imparting stability to the installation of the plumbing fixture.

In an embodiment, the fitting member 580 may comprise a plurality of protrusions 580 disposed on the outer surface of the inner member as illustrated in FIG. 7. A plurality of protrusions 580 may be particularly advantageous because the voids between the plurality of protrusions 580 provide space to accommodate for debris that may fall in between the inner member 530 and the outer member of the extendable flange during installation. Without the voids, debris that fell in between the inner member 530 and the outer member would jam the inner member 530 and the outer member, rendering the extendable flange unextendable. In another embodiment, other suitable fitting member 580 may include at least one rib member extending laterally or longitudinally along the outer surface of the inner member 530.

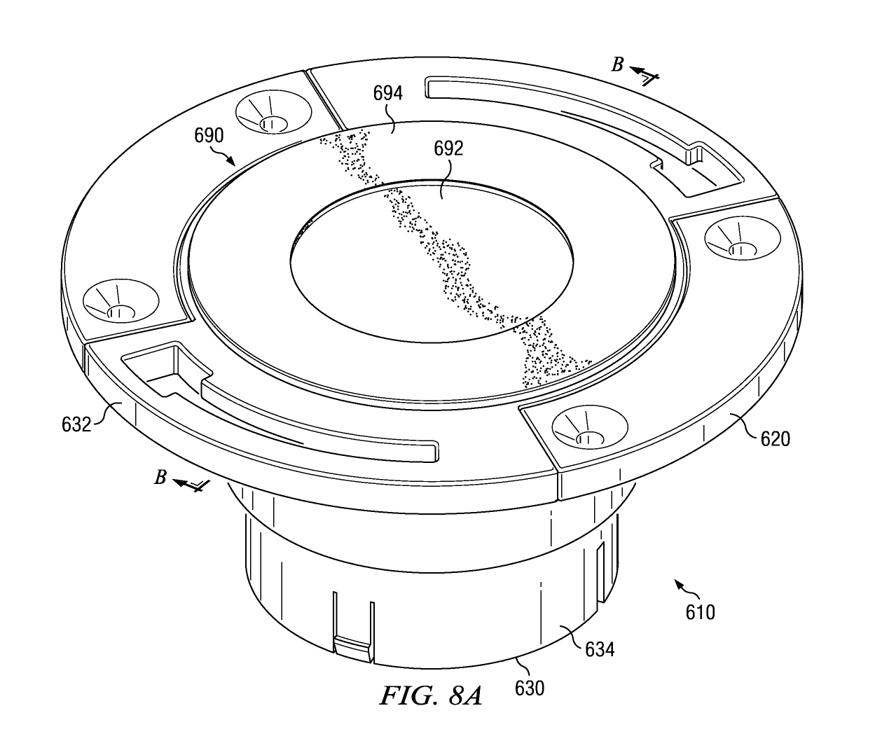

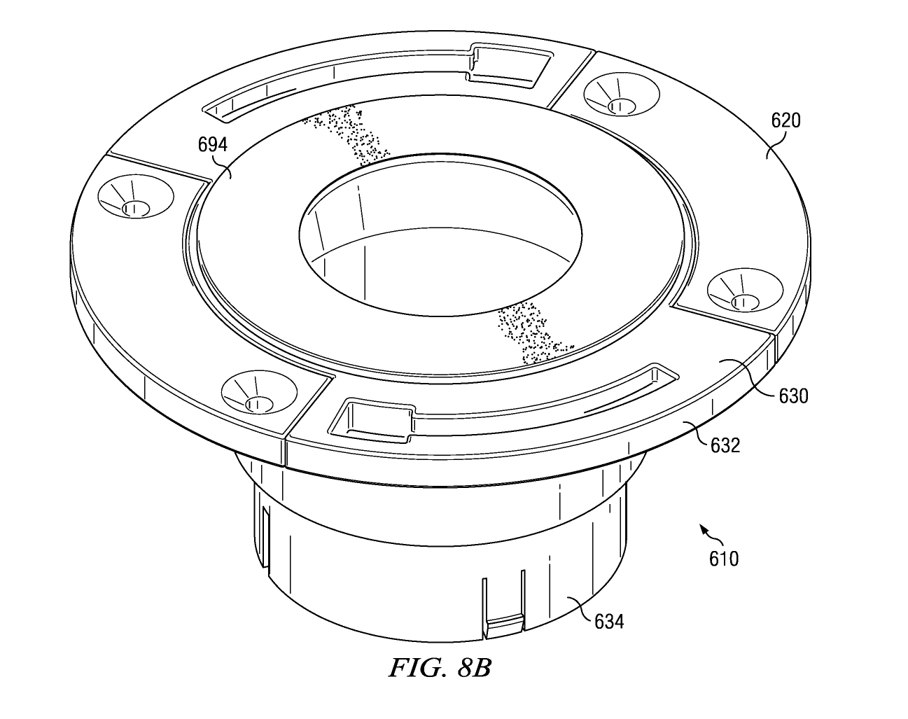

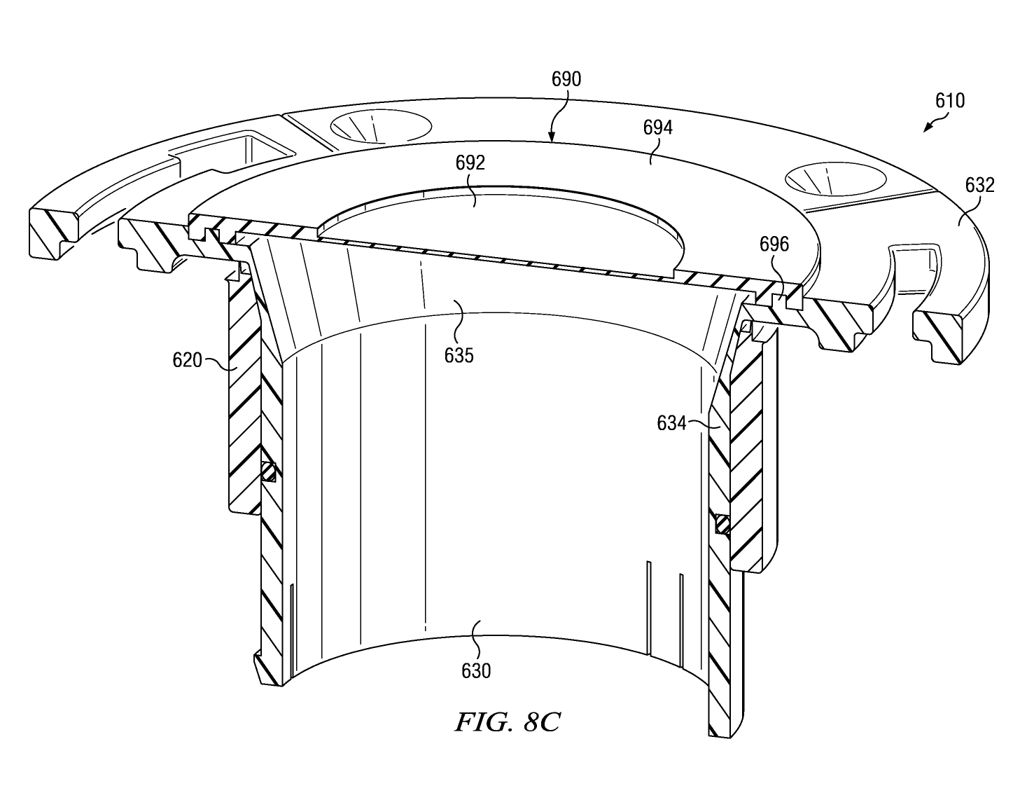

FIG. 8A is a perspective view of an extendable flange apparatus 610 comprising an inner member 630 slidably coupled to an outer member 620. The inner member 630 further includes a sealing member 690 disposed at an upper end of the inner tubular body 634 of the inner member 630. The sealing member 690 is operable to provide a seal between the flange 610 and the discharge of a plumbing fixture. In an embodiment, the sealing element 690 may be integrally formed with the inner member 630. In another embodiment, the sealing member 690 may be laminated or spin-welded to the inner member 630. In some embodiments, a top surface of the upper end portion 635 of the inner member 630 comprises an upwardly extending ring member 696 as shown in FIG. 8C, and the sealing member 690 is welded over the ring member 696 onto the top surface of the upper end portion 635 of the inner member 630.

One embodiment of the inner member 630 comprises one or more o-rings used as the sealing member 690. In some embodiments, the sealing member 690 comprises a flexible membrane 690 that may include a central detachable portion 692 and a circumferential, inwardly-extending lip portion 694. Such a membrane is operable to prevent the gases from the plumbing system to escape into the building before the plumbing fixture is install. If the plumbing code requires it, the flexible membrane 690 also allows for a leak test of the plumbing system to be conducted without the use of an additional part to plug or cap the flange connection to the waste drain pipe. When the central detachable portion 692 is removed during installation, the remaining circumferential lip portion 694 is operable to be bent downwardly when engaged by the discharge of the plumbing fixture. FIG. 8B is a perspective view of the inner member 630 after the detachable portion 692 has been removed. As such, the flexible inwardly extending lip 694 is operable to provide a sealed connection to the discharge of a plumbing fixture as the flange portion 632 of the inner member 630 is coupled to the plumbing fixture and pulled upwardly.

In some embodiments, the circumferential lip 694 of the membrane 690 may extend both inwardly and upwardly and have a raised profile. The raised profile of the circumferential lip 694 allows for additional accommodation for the potential gap between the seating level of a flange apparatus and the finished floor level. The raised circumferential lip 694 is particularly advantageous in embodiments in which the gap between the seating level of a flange apparatus and the finished floor level is longer than the length of the inner member of an extendable flange of the present disclosure. In some embodiments, the flexible membrane 690 includes only the circumferential lip 694 but not the central detachable portion 692, in which case, the circumferential lip 694 defines a central opening in the flexible membrane 690.

It should be appreciated that the breadth and scope of the invention(s) should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. An extendable flange apparatus, comprising:
an outer member comprising an outer tubular body and a first flange portion extending outwardly from an upper end portion of the outer tubular body, the first flange portion defining a first plane; and
an inner member slidably coupled to the outer member, the inner member comprising an inner tubular body and a second flange portion extending outwardly from an upper end of the inner tubular body, the second flange portion defining a second plane;
wherein the outer tubular body has a central opening defined therethrough, and the inner tubular body is at least partially disposed within the central opening of the outer tubular body, the inner tubular body being operable to slide longitudinally, from a leveled position to an extended position;
wherein the first and second planes of the first and second flange portions, respectively, are substantially coplanar when the inner tubular body is in the leveled position, and the first plane is in a spaced relation with the second plane when the inner tubular body is in the extended position.

2. The extendable flange apparatus of claim 1, wherein the inner member further comprises at least one latch disposed at a lower end portion of the inner tubular body, the latch being operable to cooperate with a lower end portion of the outer tubular body to prevent the inner and outer members from being completely disassembled.

3. The extendable flange apparatus of claim 2, wherein the inner member further comprises a plurality of latches disposed at a lower end portion of the inner tubular body, the plurality of latches being operable to cooperate with a lower end portion of the outer tubular body to prevent the inner and outer members from being completely disassembled.

4. The extendable flange apparatus of claim 2, wherein the at least one latch comprises a proximal edge portion being substantially orthogonal to an outer surface of the inner tubular body and a tapering distal edge portion.

5. The extendable flange apparatus of claim 1,
wherein the inner member comprises a longitudinal channel defined in an outer surface of the inner member, and the outer member comprises a guide element extending from an inner surface of the outer member;
wherein the inner and outer member are aligned such that the guide element extends into the longitudinal channel; and
wherein the guide element and the longitudinal channel are operable to cooperate with each other to substantially limit the rotational movement of inner and outer members relative to each other.

6. The extendable flange apparatus of claim 1,
wherein the outer member comprises a longitudinal channel defined in an inner surface of the outer member, and the inner member comprises a guide element extending from an outer surface of the inner member;
wherein the inner and outer member are aligned such that the guide element extends into the longitudinal channel; and
wherein the guide element and the longitudinal channel are operable to cooperate with each other to substantially limit the rotational movement of inner and outer members relative to each other.

7. The extendable flange apparatus of claim 1, further comprising a sealing member disposed between the inner and outer members, wherein the inner or outer member comprises a circumferential groove defined therein, and the sealing member is substantially seated in the circumferential groove.

8. The extendable flange apparatus of claim 1, further comprising at least one fitting member disposed on an outer surface of the inner member, the fitting member dimensioned to span a gap between the outer surface of the inner member and an inner surface of the outer member, thereby substantially limiting lateral movements of the inner and outer members relative to each other.

9. The extendable flange apparatus of claim 8, wherein the fitting member comprises a plurality of protrusions disposed on the outer surface of the inner member.

10. The extendable flange apparatus of claim 8, wherein the fitting member comprises at least one rib extending laterally or longitudinally along the outer surface of the inner member.

11. The extendable flange apparatus of claim 8, wherein the fitting member and the inner member are integrally formed.

12. The extendable flange apparatus of claim 8, wherein the fitting member and the inner member are releasably coupled.

13. An extendable flange apparatus, comprising:
an outer member comprising an outer tubular body and a first flange portion extending outwardly from an upper end portion of the outer tubular body, the first flange portion defining a first plane; and
an inner member slidably coupled to the outer member, the inner member comprising:
an inner tubular body;
a second flange portion extending outwardly from an upper end portion of the inner tubular body, the second flange portion defining a second plane; and
a sealing member disposed at the upper end portion of the inner tubular body, the sealing member operable to provide a substantially sealed connection to a discharge of a plumbing fixture;
wherein the outer tubular body has a central opening defined therethrough, and the inner tubular body is at least partially disposed within the central opening of the outer tubular body, the inner tubular body being operable to slide longitudinally, from a leveled position to an extended position;
wherein the first and second planes of the first and second flange portions, respectively, are substantially coplanar when the inner tubular body is in the leveled position, and the first plane is in a spaced relation with the second plane when the inner tubular body is in the extended position.

14. The extendable flange apparatus of claim 13, wherein the sealing member comprises a flexible membrane, the flexible membrane comprising a central detachable portion and a circumferential, inwardly-extending lip portion operable to be bent downwardly when engaged by the discharge of the plumbing fixture.

15. The extendable flange apparatus of claim 14, wherein a top surface of the upper end portion of the inner member comprises an upwardly extending ring member, and the flexible membrane is welded over the upwardly extending ring member onto the top surface of the upper end portion of the inner member.

16. The extendable flange apparatus of claim 13, wherein the sealing member comprises a flexible membrane, the flexible membrane comprising a circumferential lip portion, the circumferential lip portion defining a central opening, wherein circumferential lip extends inwardly and upwardly from the upper end portion of the inner member and is operable to be bent downwardly when engaged by the discharge of the plumbing fixture.

17. The extendable flange apparatus of claim 13, wherein the sealing member comprises an o-ring.

18. A method of assembling an extendable flange apparatus, comprising:
providing an outer member comprising an outer tubular body and a first flange portion extending outwardly from an upper end portion of the outer tubular body, the first flange portion defining a first plane, wherein the outer tubular body has a central opening defined therethrough;
providing an inner member comprising an inner tubular body and a second flange portion extending outwardly from an upper end of the inner tubular body, the second flange portion defining a second plane; and
disposing the inner member at least partially within the central opening of the outer tubular body such that the inner and outer members are slidably coupled.

19. The method of assembling an extendable flange apparatus according to claim 18, further comprising:
forming a longitudinal channel defined in an outer surface of the inner member;
forming a guide element extending from an inner surface of the outer member; and
aligning the inner and outer member such that the guide element extends into the longitudinal channel;
wherein the guide element and the longitudinal channel are operable to cooperate with each other to substantially limit the rotational movement of inner and outer members relative to each other.

20. The method of assembling an extendable flange apparatus according to claim 18, further comprising:
connecting a flexible membrane to an upper end portion of the inner tubular body, the flexible membrane comprising a central detachable portion and a circumferential, inwardly-extending lip portion,
wherein, when the detachable portion is removed, the lip portion is operable to be bent downwardly when engaged by the discharge of the plumbing fixture.

21. The method of assembling an extendable flange apparatus according to claim 20, further comprising removing the central detachable portion of the flexible membrane.
